(19) United States
(12) Patent Application Publication
(10) Pub. No.: US 2017/0038974 A1
(43) Pub. Date: Feb. 9, 2017

(54) STORAGE DEVICE CHANGING CONDITION PARAMETER VALUE BASED ON AGING LEVEL AND METHOD FOR MANAGING THE SAME

(71) Applicant: Samsung Electronics Co., Ltd., Suwon-si (KR)

(72) Inventor: Sunil KESHAVA, Suwon-si (KR)

(21) Appl. No.: 15/151,474

(22) Filed: May 10, 2016

(30) Foreign Application Priority Data
Aug. 3, 2015 (KR) 10-2015-0109651

(51) Int. Cl. G06F 3/06; G06F 13/42; G06F 13/16

(52) U.S. Cl. CPC G06F 3/0604; G06F 3/0619; G06F 3/0653; G06F 3/0659; G06F 3/0647; G06F 3/0688; G06F 13/1668; G06F 13/42

(57) ABSTRACT

A storage device includes one or more nonvolatile memories, and a memory controller that controls the nonvolatile memories. The memory controller receives a new value from a host in compliance with a sideband interface protocol that is separate from a main interface protocol for transmitting normal data, such that an existing value of a condition parameter associated with an operation condition of the nonvolatile memories and the memory controller is changed into the new value. The new value is changed according to an aging level of the nonvolatile memories.

### CROSS-REFERENCE TO RELATED APPLICATIONS

The present application claims priority under 35 U.S.C. §119 to Korean Patent Application No. 10-2015-0109651, filed on Aug. 3, 2015, in Korean Intellectual Property Office, the entire contents of which are incorporated herein by reference.

### TECHNICAL FIELD

The present disclosure relates to an electronic device, and more particularly, to a storage device for storing data and a method for managing the same.

### DESCRIPTION OF THE RELATED ART

Electronic devices and systems are becoming commonplace throughout the world. Electronic devices come in a variety types and shapes, and have a variety of capabilities. One kind of electronic device is a storage device capable of storing data. In general, a storage devices can store data received from a host, and can transmit the stored data to the host in response to a request from the host. Depending on an operation of the storage device, various services may be provided to a user.

Various electronic devices including the storage device may operate in compliance with at least one interface protocol to interface with other devices or a user. For example, the storage device may employ a communication interface protocol to exchange of data with the host. Further, the storage device may employ a “sideband interface protocol” for performing a control operation and a management operation including debugging, monitoring, or the like.

Various electronic devices including the storage device can manage a “condition parameter” associated with their operation conditions. For example, the storage device can store a value of the condition parameter associated with the operation condition, such as a threshold of an operation temperature, delay of data transmission, or the like. Further, the storage device may operate based on the stored value of the condition parameter. For example, the storage device may be controlled such that the operation temperature of the storage device does not exceed the threshold based on a parameter value associated with the threshold of the operation temperature.

### SUMMARY

The present disclosure may provide a storage device. In some example embodiments, the storage device may include one or more nonvolatile memories, and a memory controller configured to control the one or more nonvolatile memories. The memory controller may receive a new value from a host in compliance with a sideband interface protocol, the sideband interface protocol being separate from a main interface protocol for transmitting normal data. The memory controller may manage a condition parameter associated with an operation condition of the one or more nonvolatile memories and the memory controller. The memory controller may change an existing value of the condition parameter into the new value according to an aging level of the one or more nonvolatile memories.

The present disclosure may provide a method of managing a storage device including one or more nonvolatile memories. In some example embodiments, the method may include preparing parameter values, which correspond to respective different aging levels associated with the nonvolatile memories, in a memory of a host for each of one or more condition parameters associated with an operation condition of the storage device, receiving, by the host, state data associated with using states of the nonvolatile memories from the storage device, approximating, by the host, an aging level of the nonvolatile memories based on the state data, and transmitting, by the host, a parameter value corresponding to the approximated aging level from among the prepared parameter values to the storage device, for at least one of the condition parameters.

In some example embodiments, the method may include preparing, by a host, one or more parameter values respectively corresponding to different aging levels. The method may include receiving, by the host, state data from the storage device. The method may include approximating, by the host, an aging level of the one or more nonvolatile memories based on the state data. The method may include transmitting, by the host, a parameter value from among the one or more parameter values corresponding to the approximated aging level to the storage device

### BRIEF DESCRIPTION OF THE DRAWINGS

Example embodiments of the present disclosure will be described below in more detail with reference to the accompanying drawings. The present disclosure may, however, be embodied in different forms and should not be constructed as limited to the example embodiments set forth herein. Rather, these example embodiments are provided so that this disclosure will be thorough and complete, and will fully convey the scope of the present disclosure to those skilled in the art. Like numbers refer to like elements throughout.

FIG. 1 is a block diagram illustrating a storage system including a storage device in accordance with an example embodiment.

FIG. 2 is a conceptual diagram illustrating an example configuration of a storage device of FIG. 1.

FIG. 3 is a conceptual diagram describing functions of a memory controller of FIG. 1.

FIG. 4 is a conceptual diagram describing a relationship between a using state and an aging level of nonvolatile memories of FIG. 1.

FIGS. 5 and 6 are conceptual diagrams illustrating parameter values, which are prepared in a host of FIG. 1, corresponding to respective different aging levels associated with nonvolatile memories of FIG. 1.

FIG. 7 is a flowchart describing a method for managing a storage device according to an example embodiment.

FIG. 8 is a conceptual diagram describing a process of managing a storage device according to the method of FIG. 7.

FIG. 9 is a flowchart describing an operation of transmitting a parameter value from a host to a storage device according to the method of FIG. 7 in further detail.

FIG. 10 is a conceptual diagram illustrating a process of transmitting a parameter value from a host to a storage device according to the method of FIG. 7.

FIG. 11 is a flowchart describing a method of monitoring an operation of a storage device and tuning a parameter value of the storage device according to an example embodiment.

FIG. 12 is a conceptual diagram illustrating a process of tuning a parameter value by a host according to the method of FIG. 11.

FIG. 13 is a conceptual diagram illustrating a process of tuning a parameter value by a storage device according to the method of FIG. 11.

FIG. 14 is a table describing commands that may be defined for an example embodiment.

FIG. 15 is a block diagram illustrating a computing device including a storage device in accordance with an example embodiment.

FIG. 16 is a conceptual diagram illustrating a computing system including a storage device in accordance with an example embodiment.

FIG. 17 is a conceptual diagram illustrating a management system for a storage device in accordance with an example embodiment.

### DETAILED DESCRIPTION OF EMBODIMENTS

Example embodiments of the present disclosure will be described more fully hereinafter with reference to the accompanying drawings, in which the example embodiments are shown. The present disclosure may, however, be embodied in many different forms and should not be construed as limited to the example embodiments set forth herein. Rather, these example embodiments are provided so that this disclosure will be thorough and complete, and will fully convey the scope of the present disclosure to those skilled in the art. In the drawings, the size and relative sizes of layers and regions may be exaggerated for clarity. Like numbers refer to like elements throughout.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present disclosure, and will not be interpreted in an idealized or overly formal sense unless expressly so defined herein.

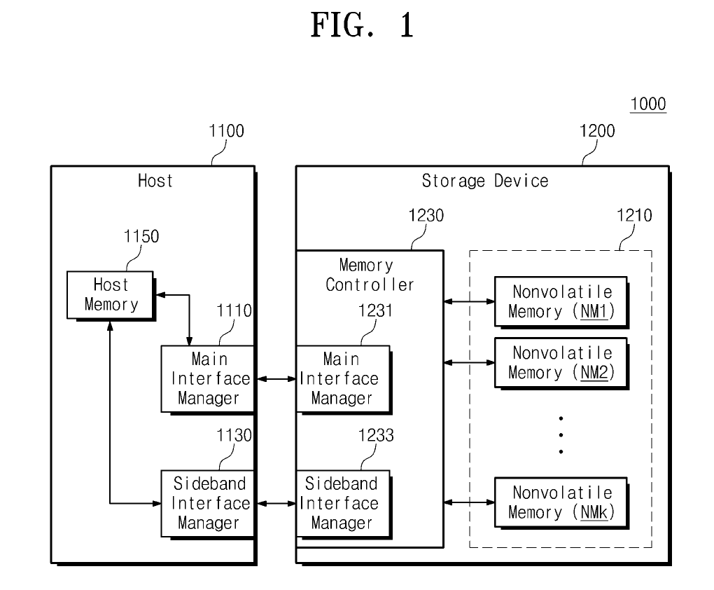

FIG. 1 is a block diagram illustrating a storage system including a storage device in accordance with an example embodiment. A storage system 1000 may include a host 1100 and a storage device 1200. The host 1100 may include a main interface manager 1110, a sideband interface manager 1130, and a host memory 1150. The host 1100 may transmit data to be stored in the storage device 1200, to the storage device 1200, and/or may receive data stored in the storage device 1200. Accordingly, the host 1100 may provide a service to a user of the storage system 1000. For example, the host 1100 may be implemented in a processor device including one or more process cores, such as a general purposed processor, a special purposed processor, an application processor, or the like.

The storage device 1200 may include one or more nonvolatile memories 1210 and a memory controller 1230. The nonvolatile memories 1210 may include, for example, k nonvolatile memories NM1 to NMk. Each of the nonvolatile memories NM1 to NMk may include a memory area to store data provided from the host 1100.

For example, when each of the nonvolatile memories NM1 to NM1 (includes a flash memory, each of the nonvolatile memories NM1 to NMk may include a memory cell array formed along a plurality of word lines and a plurality of bit lines. However, the present disclosure is not limited thereto. Each of the nonvolatile memories NM1 to NMk may include one or more various nonvolatile memories, such as a phase-change random access memory (PRAM), a magneto-resistive RAM (MRAM), a resistive RAM (ReRAM), a ferroelectric RAM (FRAM), and/or the like.

The memory controller 1230 may control overall operations of the storage device 1200. The memory controller 1230 may control the nonvolatile memories 1210. Under the control of the memory controller 1230, data stored in the nonvolatile memories 1210 may be provided to the host 1100. Alternatively or in addition, data provided from the host 1100 may be stored in the nonvolatile memories 1210. The memory controller 1230 may include a main interface manager 1231 and a sideband interface manager 1233.

The main interface managers 1110 and 1231 may communicate with each other to transmit a command and/or normal data, as further described in detail below. The main interface manager 1110 of the host 1100 may transmit data to be stored in the nonvolatile memories 1210 to the main interface manager 1231 of the storage device 1200 together with a write command. The main interface manager 1231 of the storage device 1200 may transmit data stored in the nonvolatile memories 1210 to the main interface manager 1110 of the host 1100 in response to a read command of the host 1100.

The sideband interface managers 1130 and 1233 may communicate with each other to transmit a sideband signal, as further described in detail below. A control operation and a management operation including debugging and monitoring may be performed in the storage device 1200, based on the sideband signal.

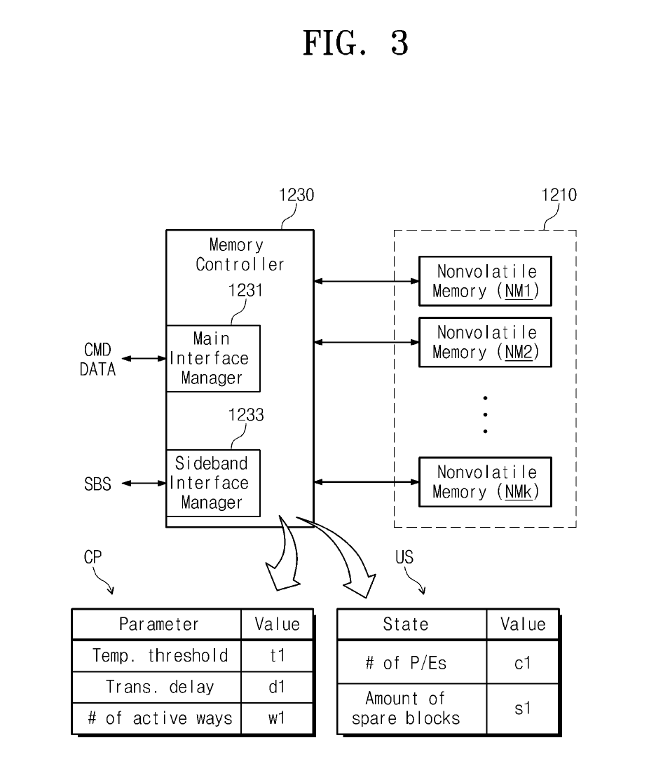

The storage device 1200 may provide data associated with a using state of the storage device 1200 to the host 1100 as the sideband signal. Alternatively or in addition, the host 1100 may provide a value of a condition parameter corresponding to an aging level of the storage device 1200 to the storage device 1200 as the sideband signal. Sideband interfacing and related functions of the memory controller 1230 in accordance with example embodiments are described below with reference to FIGS. 3 through 14.

The main interface managers 1110 and 1231 may communicate with each other in compliance with the peripheral component interconnect express (PCIe) interface protocol. However, the present disclosure is not limited thereto. The main interface managers 1110 and 1231 may employ one or more other interface protocols accompanied with a sideband interface.

For example, the sideband interface managers 1130 and 1233 may communicate with each other in compliance with a protocol defined in the management component transport protocol (MCTP) specification or the system management bus (SMBus) specification. Each of the sideband interface managers 1130 and 1233 may employ a universal asynchronous receiver and transmitter (UART) protocol or inter-integrated circuit (I2C) protocol as a physical layer. However, the present disclosure is not limited thereto. The sideband interface managers 1130 and 1233 may employ one or more various sideband interface protocols to assist the main interface managers 1110 and 1231. The sideband interface managers 1130 and 1233 may employ a sideband interface protocol that is separate from a main interface protocol.

The host memory 1150 may store data that is used in an operation of the host 1100. The host memory 1150 may include one or more various types of memories such as a cache memory, a working memory, an embedded memory, and/or the like. In some cases, data stored or to be stored in the host memory 1150 may be exchanged with the storage device 1200 through the main interface manager 1110 and/or the sideband interface manager 1130.

The host memory 1150 may store parameter values respectively corresponding to different aging levels associated with the nonvolatile memories 1210. Managing the parameter values in accordance with example embodiments is described below with reference to FIGS. 3 through 14.

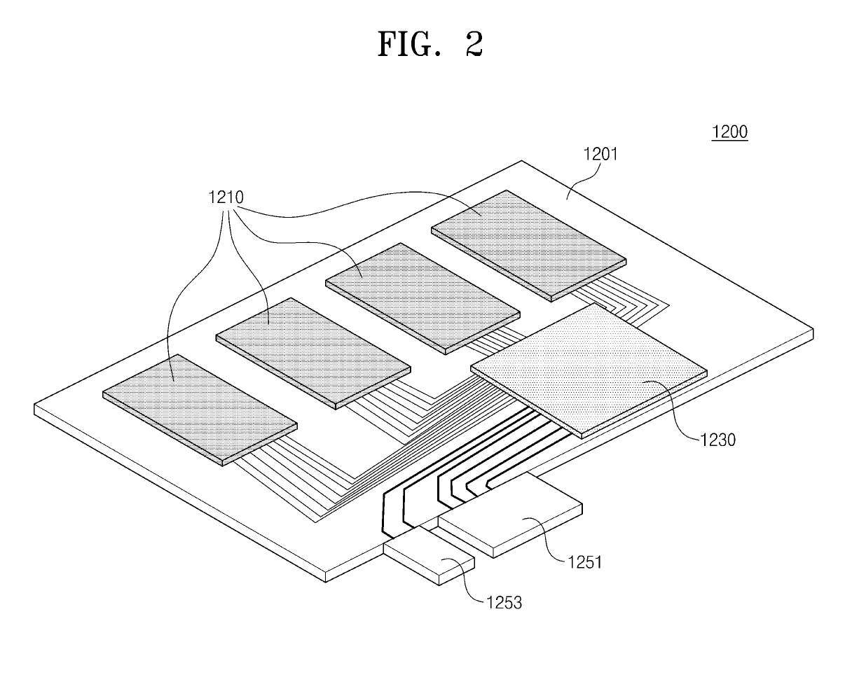

FIG. 2 is a conceptual diagram illustrating an example configuration of a storage device of FIG. 1. Reference is no made to FIGS. 1 and 2.

The storage device 1200 may include one or more nonvolatile memories 1210 and a memory controller 1230. As shown in FIG. 2, the storage device 1200 includes four nonvolatile memories 1210. It will be understood, however, that the storage device 1200 may include any suitable number of nonvolatile memories 1210.

The nonvolatile memories 1210 and the memory controller 1230 may be disposed on a printed circuit board (PCB) 1201. Each of the nonvolatile memories 1210 may be connected to the memory controller 1230 through a conductive pattern that is printed on the PCB 1201 and/or a conductor formed inside the PCB 1201. The term “conductive pattern” can refer, for example, to a wire pattern, a trace pattern, or the like. The term “conductor” can refer, for example, to a wire, a trace, a conductive plate, or the like. The memory controller 1230 may control the nonvolatile memories 1210 while communicating with the nonvolatile memories 1210 through the conductive pattern or the conductor.

The storage device 1200 may further include a main interface connector 1251 and a sideband interface connector 1253. The main interface manager 1231 of the memory controller 1230 may be connected to the main interface connector 1251 through the conductive pattern or the conductor. The sideband interface manager 1233 of the memory controller 1230 may be connected to the sideband interface connector 1253 through the conductive pattern or the conductor.

The main interface connector 1251 and the sideband interface connector 1253 may be connected to a corresponding device slot or port of a main board including or otherwise associated with the host 1100. For example, the storage device 1200 may be built in the main board included by or otherwise associated with the host 1100.

The main interface connector 1251 may provide a communication path between the main interface manager 1110 of the host 1100 and the main interface manager 1231 of the storage device 1200. The sideband interface connector 1253 may provide a communication path between the sideband interface manager 1130 of the host 1100 and the sideband interface manager 1233 of the storage device 1200.

FIG. 3 is a conceptual diagram describing functions of a memory controller of FIG. 1. Reference is now made to FIGS. 1 and 3.

The memory controller 1230 may receive a command CMD from the host 1100 of FIG. 1 through the main interface manager 1231. The memory controller 1230 may control at least one nonvolatile memory 1210 in response to the command CMD. The memory controller 1230 may exchange normal data DATA with the host 1100 through the main interface manager 1231. For example, the memory controller 1230 may receive data DATA to be stored in the nonvolatile memories 1210 in response to the command CMD. Alternatively or in addition, the memory controller 1230 may output data DATA stored in the nonvolatile memories 1210 in response to the command CMD.

In some example embodiments, the memory controller 1230 may manage one or more condition parameters CP. Each of the condition parameters CP may relate to an operation condition of the storage device 1200 of FIG. 1. More specifically, each of the condition parameters CP may relate to an operation condition of the nonvolatile memories 1210 and the memory controller 1230. For example, the condition parameters CP may include a threshold of an operation temperature, a delay of data transmission with the host 1100, a number of ways being activated in each of the nonvolatile memories NM1 to NMk, and/or the like.

For example, the storage device 1200 may be controlled to operate at a temperature below a parameter threshold value t1 associated with the threshold of the operation temperature. For example, the host 1100 and the storage device 1200 may allow delay by as much as a parameter transmission delay value d1 associated with the delay of data transmission. The number of ways being activated in each of the nonvolatile memories NM1 to NMk may not exceed a number of active ways parameter value w1. That is, the storage device 1200 may operate based on the condition parameters CP.

In some flash-based storage devices, a plurality of channels may be provided. A first channel may operate in parallel with an operation of a second channel Moreover, a plurality of flash memories may be connected with one channel. The connection between one flash memory and the corresponding channel may be referred to as a “way.” For one channel, a determined number of ways may be activated. The determined number may be modified or changed in various ways depending on a manufacturer, a type, a model, needs of customer, or the like.

More specifically, the determined number of flash memories connected with the corresponding channel may be enabled, for example, in response to a first logical value of a chip enable signal. On the other hand, remaining flash memories other than the predetermined number of flash memories may be disabled, for example, in response to a second logical value of the chip enable signal. The plurality of flash memories connected with one channel may share the corresponding channel as an input/output route. However, only the determined number of ways may be activated in response to the chip enable signal.

The examples described above are only illustrative and the present disclosure is not limited to the above examples. The condition parameters CP need not include some of the threshold of the operation temperature, the delay of data transmission between the host 1100 and the storage device 1200, and/or the number of ways being activated in each of the nonvolatile memories NM1 to NMk. Alternatively or in addition, the operation conditions CP may further include other kinds of parameters defining an operation condition of the storage device 1200. The condition parameters CP may be variously changed or modified.

For example, the parameter values t1, d1 and w1 of the condition parameters CP may be stored in the nonvolatile memories 1210, an embedded memory of the memory controller 1230, and/or a buffer memory of the storage device 1200. When the storage device 1200 operates, the memory controller 1230 may control the storage device 1200 with reference to the stored parameter values t1, d1, and w1.

In some example embodiment, the memory controller 1230 may manage state data associated with a using state US of the nonvolatile memories 1210. For example, the using state US of the nonvolatile memories 1210 may include a number of times that program and erase operations are performed in the nonvolatile memories 1210, an amount of memory blocks discarded in the nonvolatile memories 1210, and/or an amount of spare blocks to replace the discarded memory blocks. As referred to herein, a value of an “amount” may be an absolute value or a relative value (e.g., a percentage).

For example, whenever a program and erase operation is performed in the nonvolatile memories 1210, the memory controller 1230 may increase a number of program and erase operations value c1 associated with the number of times the program and erase operations are performed. Whenever a spare block replaces a discarded memory block in the nonvolatile memories 1210, the memory controller 1230 may decrease an amount of spare blocks value s1 associated with the amount of the spare blocks.

However, the examples described above are only illustrative and the present disclosure is not limited thereto. The using state US need not include some of the number of times that the program and erase operations are performed in the nonvolatile memories 1210, the amount of memory blocks discarded in the nonvolatile memories 1210, and/or the amount of spare blocks to replace the discarded memory blocks. Alternatively or in addition, the using state US may also further include other kinds of information as the criterion for use of the nonvolatile memories 1210. The using state US may be variously changed or modified.

For example, the state values c1 and s1 of the using state US may be stored in the nonvolatile memories 1210, an embedded memory of the memory controller 1230, and/or a buffer memory of the storage device 1200. The memory controller 1230 may monitor operations associated with the nonvolatile memories 1210 to change the state values c1 and s1.

The memory controller 1230 may exchange a sideband signal SBS with the host 1100 through the sideband interface manager 1233. The storage device 1200 may provide the state data associated with the using state US to the host 1100 as the sideband signal SBS. Further, the host 1100 may provide a parameter value of the condition parameter corresponding to an aging level of the nonvolatile memories 1210 to the storage device 1200 as the sideband signal SBS. A sideband interfacing by means of the sideband signal SBS is described in further detail below.

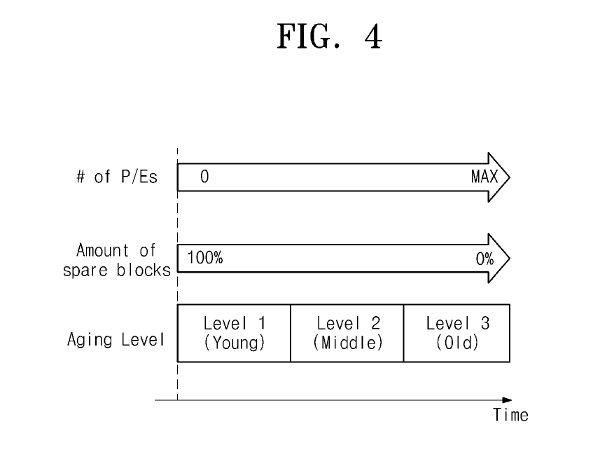

FIG. 4 is a conceptual diagram describing a relationship between a using state and an aging level of nonvolatile memories of FIG. 1. Reference is now made to FIGS. 1, 3, and 4.

As program and erase operations are repeatedly performed in the nonvolatile memories 1210, memory cells may deteriorate. Severely deteriorated memory cells may not properly store data. To ensure safe use of the storage device 1200, the memory controller 1230 may manage the number of times that program and erase operations are performed. When the number of times that program and erase operations are performed on a certain memory block reaches a reference value, the memory controller 1230 may control the nonvolatile memories 1210 such that the certain memory block does not store data any longer.

For example, immediately after the storage device 1200 is manufactured, the number of times that program and erase operations are performed in the nonvolatile memories 1210 may be zero (0). Whenever a program and erase operation is performed in the nonvolatile memories 1210, the memory controller 1230 may increase a value c1 corresponding to a number of times that the program and erase operations are performed. For example, c1 may be increased for each program operation, each erase operation, and/or each combination of a program operation and an erase operation. As time goes by, the value c1 of the number of times that the program and erase operations are performed may reach a maximum value MAX, which may be a reference value.

Thus, the number of times that program and erase operations are performed may be used to approximate an aging level of the nonvolatile memories 1210 (i.e., a deterioration level of memory cells in the nonvolatile memories 1210). For example, a mathematical formula 1 below may be used to approximate the aging level of the nonvolatile memories 1210.

$$AgingLevel = \frac{c 1}{MAX} \times 100 \% \qquad [ mathematical formula 1 ]$$

For example, when the number of times that program and erase operations are performed (i.e., the value c1) is close to 0, the aging level of the nonvolatile memories 1210 may be close to 0%. On the other hand, when the number of times that program and erase operations are performed (i.e., the value c1) is close to the maximum value MAX, the aging level of the nonvolatile memories 1210 may be close to 100%.

As described above, when the number of times that program and erase operations are performed associated with a certain memory block reaches a reference value, the memory block does not store data any longer and may be discarded. The nonvolatile memories 1210 may include spare blocks for replacing the discarded memory block. The replaced memory block may properly store data. Accordingly, a safe use of the storage device 1200 may be ensured.

For example, immediately after the storage device 1200 is manufactured, a ratio of remaining spare blocks may be 100%. Whenever a spare block replaces a discarded memory block in the nonvolatile memories 1210, the memory controller 1230 may decrease a value s1 of the amount of the remaining spare blocks. As time goes by, a ratio of the remaining spare blocks may reach 0%.

Thus, the amount (i.e., the absolute quantity) or the ratio (i.e., the relative portion) of the remaining spare blocks may be used to approximate the aging level of the nonvolatile memories 1210. For example, a mathematical formula 2 below may be used to approximate the aging level of the nonvolatile memories 1210.

$$AgingLevel = ( 1 - \frac{s 1}{INIT} ) \times 100 \% \\ ( INIT \text{:} the amount of spare blocks that are initially provided ) . \qquad [ mathematical formula 2 ]$$

For example, when the amount of remaining spare blocks (i.e., the value s1) is close to the initial amount INIT of spare blocks, the aging level of the nonvolatile memories 1210 may be close to 0%. On the other hand, when the amount of remaining spare blocks is close to zero (0), the aging level of the nonvolatile memories 1210 may be close to 100%.

As described above, the using state US of the nonvolatile memories 1210 may be used to approximate the aging level. In the examples described above, a process of approximating the aging level of the nonvolatile memories 1210 is based on the number of times of program and erase operations and the amount of remaining spare blocks, but the present disclosure is not limited to the above examples. To approximate the aging level of the nonvolatile memories 1210, other using state US criteria may be used. For example, the aging level of the nonvolatile memories 1210 may be approximated with reference to the amount of discarded memory blocks instead of the amount of remaining spare blocks. Example embodiments of the present disclosure may be variously changed or modified.

In some example embodiments, the state data associated with the using state US may be provided to the host 1100 as a sideband signal SBS. The host 1100 may approximate the aging level of the nonvolatile memories 1210 based on the using state US.

Meanwhile, as the nonvolatile memories 1210 age, performance or a characteristic of the storage device 1200 may be changed. For example, as the nonvolatile memories 1210 age, performance of the storage device 1200 may degrade, or power consumption of the storage device 1200 may increase.

As mentioned above, the storage device 1200 may operate in an operation condition defined by at least one condition parameter. When a parameter value of each of the condition parameters CP is constantly maintained even though performance or a characteristic of the storage device 1200 is changed, it may be difficult to optimize an operation of the storage device 1200. When performance or a characteristic of the storage device 1200 is changed, the storage device 1200 may require a new operation condition that is changed to optimize its operation.

Thus, when performance or a characteristic of the storage device 1200 is changed due to aging of the nonvolatile memories 1210, parameter values of condition parameters CP may need to be changed. The parameter value of each of the condition parameters CP may be changed considering performance, power consumption, stability and reliability of the storage device 1200. In some example embodiments, the parameter value of each of the condition parameters CP may be changed depending on the aging level of the nonvolatile memories 1210.

For example, an aging level of 0% to 30% of the nonvolatile memories 1210 may correspond to a first level. The first level may indicate that the nonvolatile memories 1210 are still young. An aging level of 30% to 80% of the nonvolatile memories 1210 may correspond to a second level. The second level may indicate that the aging level of the nonvolatile memories 1210 is in substantially a mid-range. An aging level of 80% to 100% of the nonvolatile memories 1210 may correspond to a third level. The third level may indicate that the nonvolatile memories 1210 are relatively old.

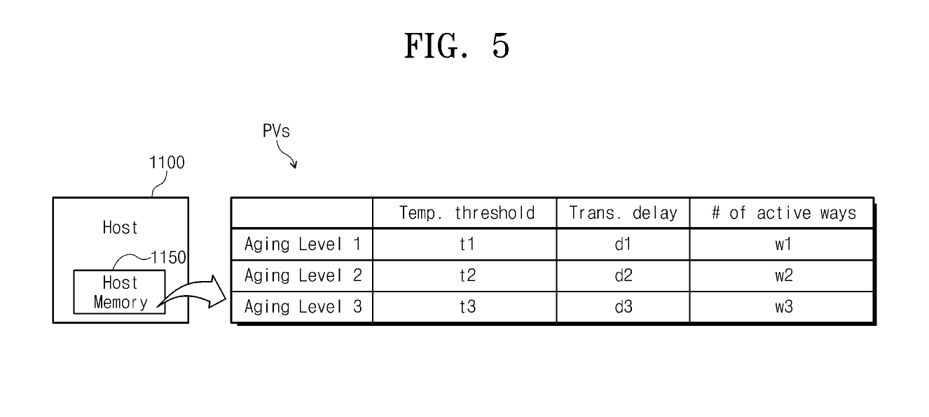

As will be further described with reference to FIGS. 5 and 6, the host 1100 may prepare parameter values respectively corresponding to different aging levels, for each of the condition parameters CP. For example, the host 1100 may prepare parameter values respectively corresponding to the first, second, and third levels in the host memory 1150.

The host 1100 may approximate the aging state of the nonvolatile memories 1210 based on the using state US of the nonvolatile memories 1210. The host 1100 may provide a new parameter value corresponding to the approximated aging level, from among the parameter values prepared in the host memory 1150, to the storage device 1200. In some example embodiments, the host 1100 may transmit the new parameter value to the storage device 1200 through the sideband interface managers 1130 and 1233. Accordingly, an existing value of each of the condition parameters CP may be changed to the new parameter value in the storage device 1200, and the storage device 1200 may operate in a new operation condition that is changed based on the new parameter value.

However, the present disclosure is not limited to the examples described above. In the above examples, it has been described that the aging levels are divided into three sections. It will be understood, however, that the aging levels may be divided into two sections, or four or more sections, and/or any suitable number of sections. Further, a percentage value to divide the aging levels may have a different value from 30% or 80%. Moreover, unlike the mathematical formulas 1 and 2, a nonlinear arithmetic operation may be employed to approximate the aging level. Example embodiments of the present disclosure may be variously changed or modified.

According to example embodiments, the storage device 1200 may be suitably managed and operate for its aging level. Thus, the storage device 1200 may effectively operate and be controlled. Moreover, the storage device 1200 may also be suitably managed and operate for its individual characteristic. For example, the storage device 1200 may be customized to satisfy a customer's and/or an end-user's needs, thereby increasing the satisfaction of the customer and/or the end-user.

FIG. 5 is a conceptual diagram illustrating parameter values, which are prepared in a host of FIG. 1, corresponding to respective different aging levels associated with nonvolatile memories of FIG. 1. Reference is now made to FIGS. 1, 3, and 5.

The host 1100 may prepare parameter values PVs in the host memory 1150. The parameter values PVs may include parameter values respectively corresponding to first, second, and third levels associated with an aging level of one or more nonvolatile memories 1210 of FIG. 1, for each of one or more condition parameters CP (of FIG. 3).

For example, the parameter values PVs may include parameter values t1, t2, and t3 respectively corresponding to the first, second, and third levels, for a threshold of an operation temperature. The parameter values PVs may include parameter values d1, d2, and d3 respectively corresponding to the first, second, and third levels, for delay of data transmission between the host 1100 and the storage device 1200 of FIG. 1. The parameter values PVs may include parameter values w1, w2, and w3 respectively corresponding to the first, second, and third levels, for the number of ways being activated in each of the nonvolatile memories NM1 to NMk of FIG. 1.

The parameter values PVs may be prepared by performing a test one or more times. For example, the parameter values t1, d1, and w1 that enable the most efficient operation with respect to the first level may be obtained by testing an operation of the storage device 1200 that includes the nonvolatile memories 1210 having an aging level of the first level. The parameter values t2, d2, and w2 that enable the most efficient operation with respect to the second level may be obtained by testing an operation of the storage device 1200 that includes the nonvolatile memories 1210 having an aging level of the second level. Further, the parameter values t3, d3, and w3 that enable the most efficient operation with respect to the third level may be obtained by testing an operation of the storage device 1200 that includes the nonvolatile memories 1210 having an aging level of the third level.

The obtained parameter values PVs may be prepared in the host memory 1150 in advance, for example, before the host 1100 begins to manage the storage device 1200 by means of the parameter values PVs according to the example embodiments. As will be further described later, a parameter value corresponding to the aging level of the storage device 1200, from among the parameter values PVs, may be provided to the storage device 1200.

FIG. 6 is a conceptual diagram illustrating parameter values, which are prepared in the host of FIG. 1, corresponding to respective different aging levels associated with nonvolatile memories of FIG. 1.

The host 1100 may prepare parameter values PVs in the host memory 1150. The parameter values PVs may include parameter values respectively corresponding to first, second, and third levels associated with an aging level of one or more nonvolatile memories 1210 of FIG. 1, for each of one or more condition parameters CP (of FIG. 3).

Unlike the example illustrated in FIG. 5, an example shown in FIG. 6 illustrates parameter values PVs prepared when further considering a power consumption state of the storage device 1200 of FIG. 1. For example, a state A may correspond to a case where the storage device 1200 completely operates and consumes the largest amount of power. A state B may correspond to a case where the storage device 1200 consumes a moderate amount of power in an idle state or a standby state. A state C may correspond to a case where the storage device 1200 consumes a least amount of power in a sleep state or a hibernate state.

The parameter values PVs of FIG. 6 may be obtained by testing operations of the storage devices 1200 having different aging levels in different power consumption states. For example, parameter values t1a, t1b, t1c, d1a, d1b, d1c, w1a, w1b, and w1c that enable the most efficient operation with respect to the first level may be obtained by testing an operation of the storage device 1200 including the nonvolatile memories 1210 that have an aging level of the first level. The parameter values t1a, t1b, t1c, d1a, d1b, d1c, w1a, w1b, and w1c associated with the first level may include parameter values t1a, d1a, and w1a that enable the most efficient operation in the state A, parameter values t1b, d1b, and w1b that enable the most efficient operation in the state B, and parameter values t1c, d1c, and w1c that enable the most efficient operation in the state C.

Similarly, parameter values t2a, t2b, t2c, d2a, d2b, d2c, w2a, w2b, and w2c that enable the most efficient operation with respect to the second level may be obtained by testing an operation of the storage device 1200 including the nonvolatile memories 1210 that have an aging level of the second level. Parameter values t3a, t3b, t3c, d3a, d3b, d3c, w3a, w3b, and w3c that enable the most efficient operation with respect to the third level may be obtained by testing an operation of the storage device 1200 including the nonvolatile memories 1210 that have an aging level of the third level.

The obtained parameter values PVs may be prepared in the host memory 1150 in advance, for example, before the host 1100 begins to manage the storage device 1200 by means of the parameter values PVs according to the example embodiments. As will be described later, a parameter value corresponding to the aging level of the storage device 1200, from among the parameter values PVs, may be provided to the storage device 1200.

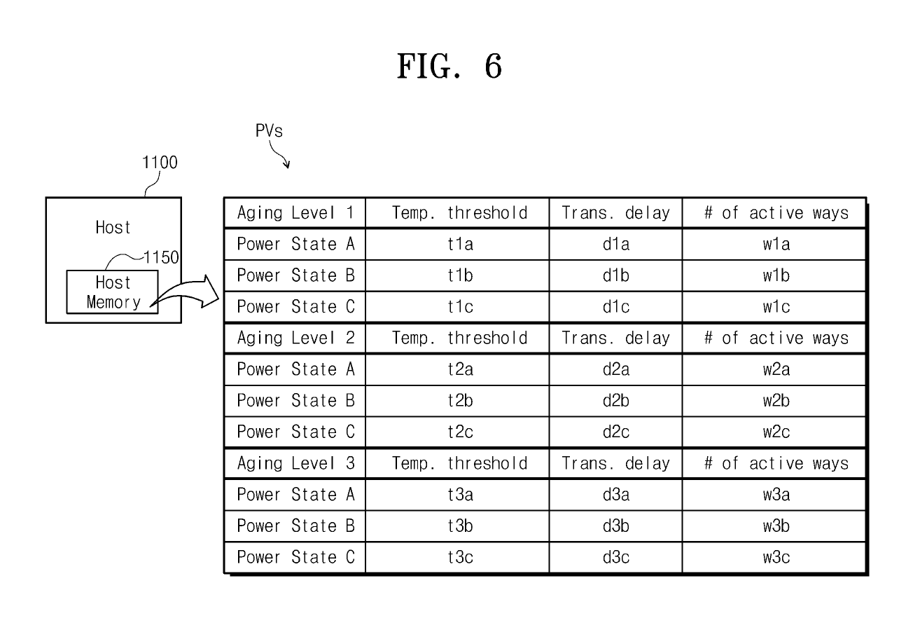

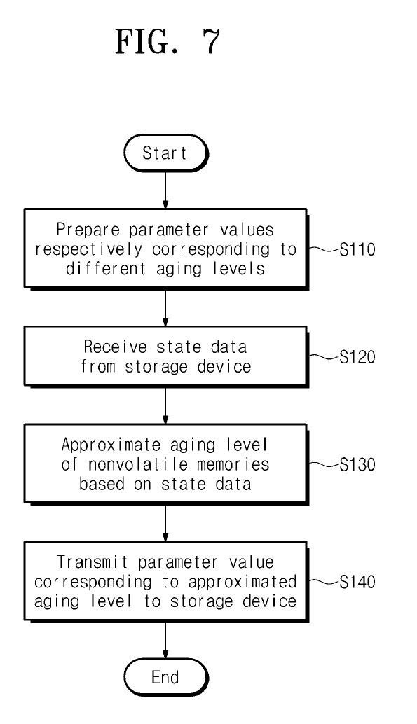

FIG. 7 is a flowchart describing a method for managing a storage device according to an example embodiment. FIG. 8 is a conceptual diagram describing a process of managing a storage device according to the method of FIG. 7. Reference is now made to FIGS. 7 and 8.

In an operation S110 of FIG. 7, the host 1100 may prepare parameter values PVs for each of one or more condition parameters CP associated with an operation condition of the storage device 1200 of FIG. 1. The host 1100 may prepare the parameter values PVs in the host memory 1150 (e.g., refer to an operation \textcircled{1} of FIG. 8). The prepared parameter values PVs may respectively correspond to different aging levels associated with the nonvolatile memories 1210 of FIG. 1. Preparing the parameter values PVs is described above with reference to FIGS. 5 and 6.

After the parameter values PVs are prepared, the host 1100 may transmit an initiation command INIT_CMD to the memory controller 1230 of the storage device 1200 through the sideband interface manager 1130 of FIG. 1 (e.g., refer to an operation \hat{2} of FIG. 8). The initiation command INIT_CMD may be transmitted to initiate an operation of managing the storage device 1200. The memory controller 1230 may receive the initiation command INIT_CMD through the sideband interface manager 1233.

In an operation S120 of FIG. 7, the host 1100 may receive state data associated with an using state US of the nonvolatile memories 1210 from the memory controller 1230 of the storage device 1200 (e.g., refer to an operation \textcircled{3} of FIG. 8). As described above with reference to FIG. 3, the memory controller 1230 may manage the using state US of the nonvolatile memories 1210. The memory controller 1230 may provide the state data associated with the using state US to the host 1100 in response to a request (i.e., the initiation command INIT_CMD) of the host 1100. The state data associated with the using state US may be transmitted through the sideband interface managers 1233 and 1130.

In an operation S130 of FIG. 7, the host 1100 may approximate an aging level of the nonvolatile memories 1210 based on the state data (e.g., refer to an operation \textcircled{4} of FIG. 8). As described with reference to FIG. 4, the using state US may include information that enables an approximation of the aging level of the nonvolatile memories 1210. The host 1100 may select a parameter value corresponding to the approximated aging level of the nonvolatile memories 1210 from among the parameter values PVs prepared in the host memory 1150 of the host 1100. Approximating the aging level is described above with reference to FIG. 4.

In an operation S140 of FIG. 7, the host 1100 may transmit the parameter value corresponding to the approximated aging level to the memory controller 1230 of the storage device 1200 (e.g., refer to an operation \textcircled{5} of FIG. 8). The host 1100 may transmit the parameter value to the storage device 1200 through the sideband interface manager 1130 (of FIG. 1). The memory controller 1230 may receive the parameter value through the sideband interface manager 1233.

As described with reference to FIG. 3, the memory controller 1230 may manage one or more condition parameters CP associated with an operation condition of the storage device 1200. In the memory controller 1230, an existing value PVe of each of the condition parameters CP may be changed into a new value PVn based on the parameter value received through the sideband interface manager 1233 (e.g., refer to an operation \textcircled{6} of FIG. 8). The new value PVn may include a parameter value corresponding to the approximated aging level of the nonvolatile memories 1210. The parameter value may be provided from the host 1100 in the operation S140 of FIG. 7. That is, the new value PVn may be changed depending on the aging level of the nonvolatile memories 1210.

According to example embodiments, an operation condition of the storage device 1200 may be changed depending on the aging level of the nonvolatile memories 1210. Thus, the storage device 1200 may operate under an operation condition that is suitable for its characteristic.

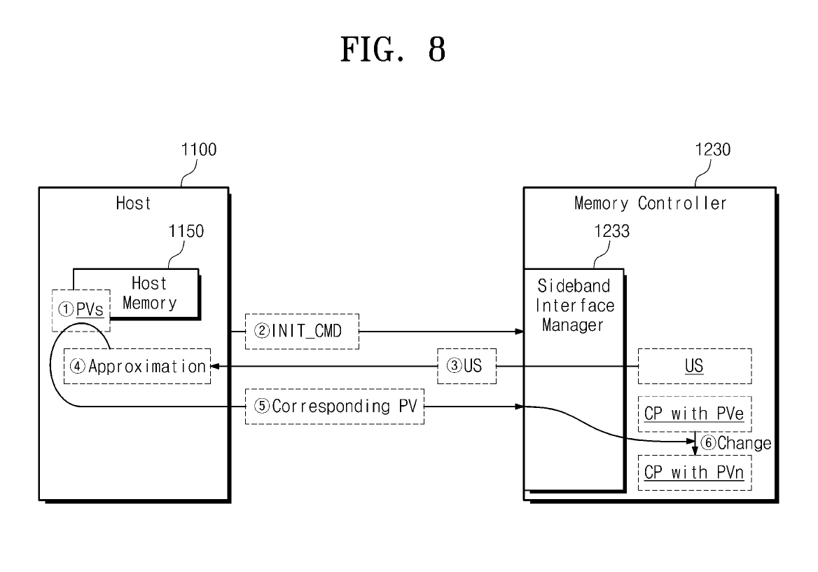

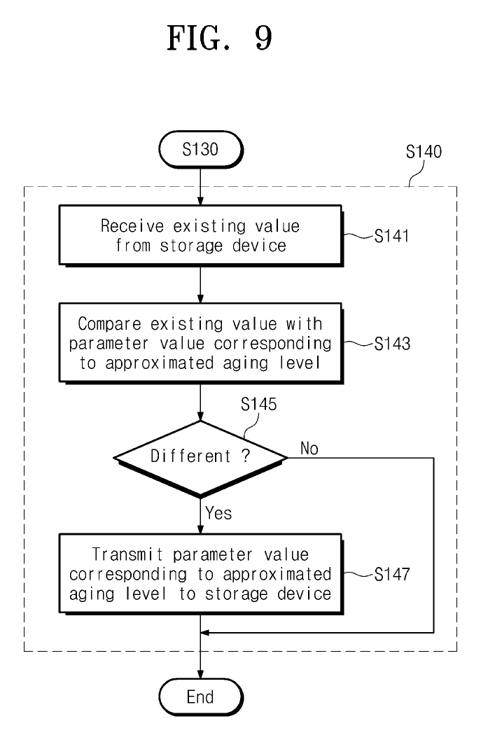

FIG. 9 is a flowchart describing an operation of transmitting a parameter value from a host to a storage device according to the method of FIG. 7 in further detail. FIG. 10 is a conceptual diagram illustrating a process of transmitting a parameter value from a host to a storage device according to the method of FIG. 7. Reference is now made to FIGS. 7, 9, and 10.

As described with reference to FIG. 7, the host 1100 may receive state data associated with a using state of the nonvolatile memories 1210 of FIG. 1. The host 1100 may approximate an aging level of the nonvolatile memories 1210 based on the using state. For illustrative purpose, it is assumed that the nonvolatile memories 1210 have an aging level corresponding to the second level.

The host 1100 may transmit a parameter value corresponding to the approximated aging level to the storage device 1200 of FIG. 1. More specifically, the operation S140 of FIG. 7 for transmitting the parameter value may include operations S141 to S147 of FIG. 9.

In an operation S141 of FIG. 9, the host 1100 may receive an existing value PVe of each of condition parameters CP from the storage device 1200. Referring to FIG. 10, the existing value PVe may be a parameter value that defines an existing operation condition of the storage device 1200. The host 1100 may receive existing values t1a, t1b, and t1c associated with a threshold of an operation temperature, existing values d1a, d1b, and d1c associated with a delay of data transmission, and existing values w1a, w1b, and w1c associated with the number of ways being activated.

In an operation S143 of FIG. 9, the host 1100 may compare a parameter value corresponding to the approximated aging level from among the parameter values prepared in the host memory 1150 of FIG. 1 with the existing value PVe received in the operation S141. Since it is assumed that the aging level corresponds to the second level, the host 1100 may compare a parameter value corresponding to the second level with the existing value PVe.

In an operation S145 of FIG. 9, it may be determined whether the parameter value corresponding to the second level is different from the existing value PVe. When the parameter value corresponding to the second level is the same as the existing value PVe, the condition parameters CP may already have parameter values corresponding to the aging level of the nonvolatile memories 1210. Thus, without an operation of changing a parameter value, the method of FIG. 8 may end.

On the other hand, when the parameter value corresponding to the second level is different from the existing value PVe, an operation of changing a parameter value may be performed to optimize an operation of the storage device 1200. Thus, in an operation S147 of FIG. 9, the host 1100 may transmit the parameter value corresponding to the approximated aging level to the memory controller 1230 of the storage device 1200.

In some example embodiments, comparing parameter values may be performed on each of condition parameters CP. Referring to FIG. 10, for example, with respect to a threshold of an operation temperature, parameter values t2a, t2b, and t2c corresponding to the second level may be compared with the existing values t1a, t1b, and t1c. In some cases, the parameter values t2a, t2b, and t2c corresponding to the second level may be different from the existing values t1a, t1b, and t1c. In these cases, the parameter values t2a, t2b, and t2c corresponding to the second level may be transmitted to the memory controller 1230.

Under the control of the memory controller 1230, the existing value PVe of the condition parameters CP may be changed into the new value PVn. For example, the existing values t1a, t1b, and t1c associated with a threshold of an operation temperature may be changed into the new values t2a, t2b, and t2c, respectively. These new values t2a, t2b, and t2c may include parameter values corresponding to the second level. The parameter values may be provided from the host 1100 in compliance with a sideband interface protocol.

Similarly, with respect to the delay of data transmission, parameter values d2a, d2b, and d2c corresponding to the second level may be compared with the existing values d1a, d1b, and d1c, respectively. In some cases, the parameter values d2a, d2b, and d2c corresponding to the second level may be different from the existing values d1a, d1b, and d1c, respectively. In these cases, the parameter values d2a, d2b, and d2c corresponding to the second level may be transmitted to the memory controller 1230. Under the control of the memory controller 1230, the existing values d1a, d1b, and d1c associated with delay of data transmission may be changed into new values d2a, d2b, and d2c, respectively.

Further, with respect to the number of ways being activated, parameter values w2a, w2b, and w2c corresponding to the second level may be compared with the existing values w1a, w1b, and w1c, respectively. However, in some cases, the parameter values w2a, w2b, and w2c corresponding to the second level may be the same as the existing values w1a, w1b, and w1c, respectively. In these cases, the existing values w1a, w1b, and w1c with respect to the number of ways being activated may be maintained without change.

However, the example embodiment described with reference to FIGS. 9 and 10 is only one of possible several embodiments of the present disclosure, and the present disclosure is not limited to this example embodiment. For example, the comparison operation may be performed for each of different power consumption states or for all of the parameter values corresponding to a specific aging level, instead of being performed on each of the condition parameters CP. Alternatively or in addition, without the comparison operation, the existing value PVe may be directly changed into the new value PVn. The example embodiments may be variously changed or modified.

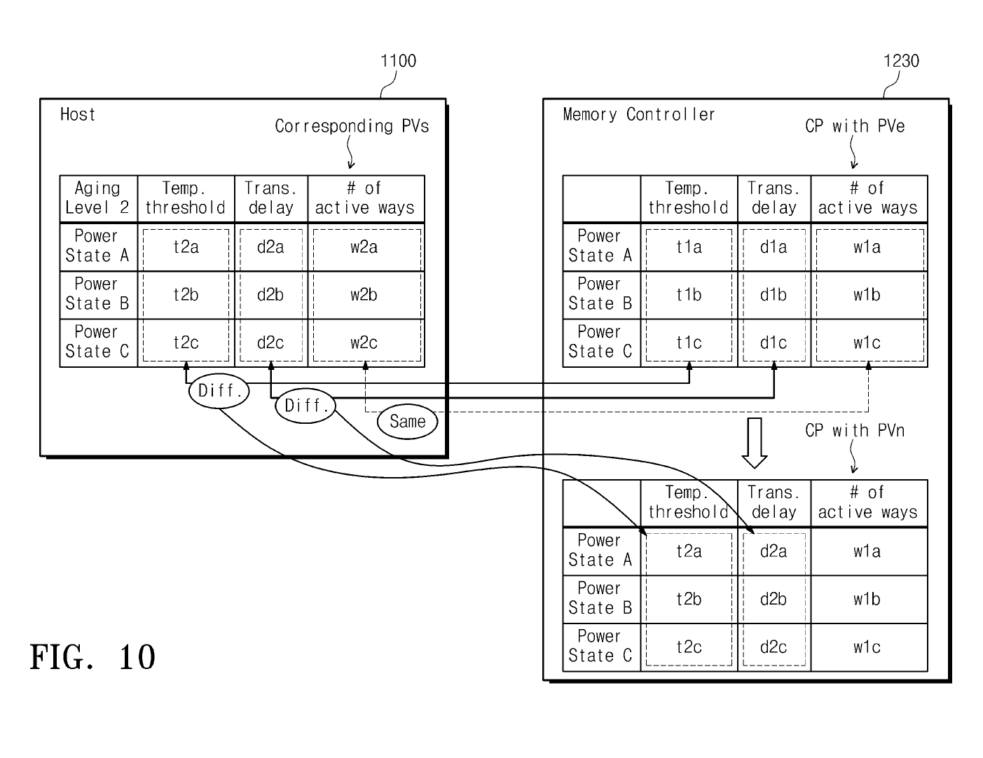

FIG. 11 is a flowchart describing a process of monitoring an operation of a storage device and tuning a parameter value of the storage device according to an example embodiment.

The method of FIG. 11 may be performed after the operation S140 of FIG. 7 for transmitting a parameter value to the storage device 1200 (of FIG. 1). After parameter values of condition parameters are changed, an operation of the storage device 1200 may be monitored and managed according to the method of FIG. 11.

In an operation S150, a normal operation of the storage device 1200 may be monitored. The normal operation may be performed by storing or outputting normal data in compliance with a main interface protocol, not a sideband interface protocol. After the parameter values of the condition parameters are changed, operation performance and power consumption of the storage device 1200 performing the normal operation may be monitored.

In an operation S160, it may be determined whether operation performance and power consumption of the storage device 1200 performing the normal operation meet a requirement level. There may be operation performance and power consumption expected or required with respect to the storage device 1200 under a specific operation condition. For example, the requirement level may be provided in a specification of an interface protocol or may be determined by a customer's request. Based on a monitoring result of the operation S150, it may be determined whether the operation performance and/or the power consumption meet the requirement level. When the operation performance and/or the power consumption meet the requirement level, the parameter values of the condition parameters may have been properly changed already. Thus, the method of FIG. 11 may end.

On the other hand, when the operation performance and the power consumption do not meet the requirement level, further processing is needed to bring the operation performance and/or the power consumption into compliance with the requirement level. For example, in an operation S170, a parameter value of at least one of the condition parameters may be tuned. Further, in an operation S180, the tuned parameter value may be transmitted to the storage device 1200. Based on the tuned parameter value, an operation condition of the storage device 1200 may be further changed. Under the changed operation condition, the storage device 1200 may show the operation performance and/or the power consumption that meet the requirement level.

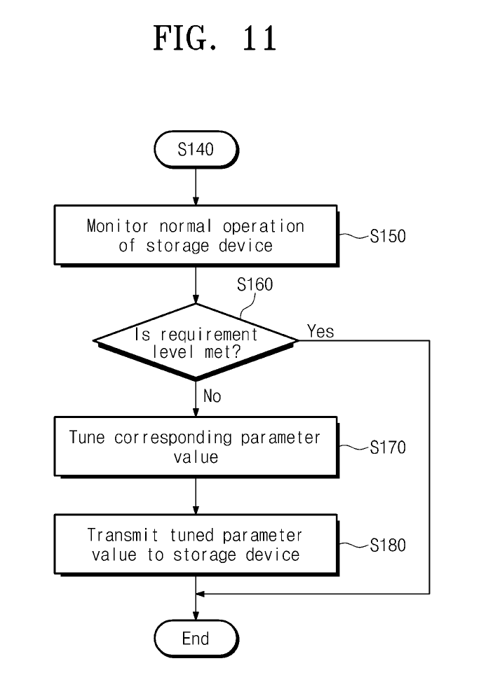

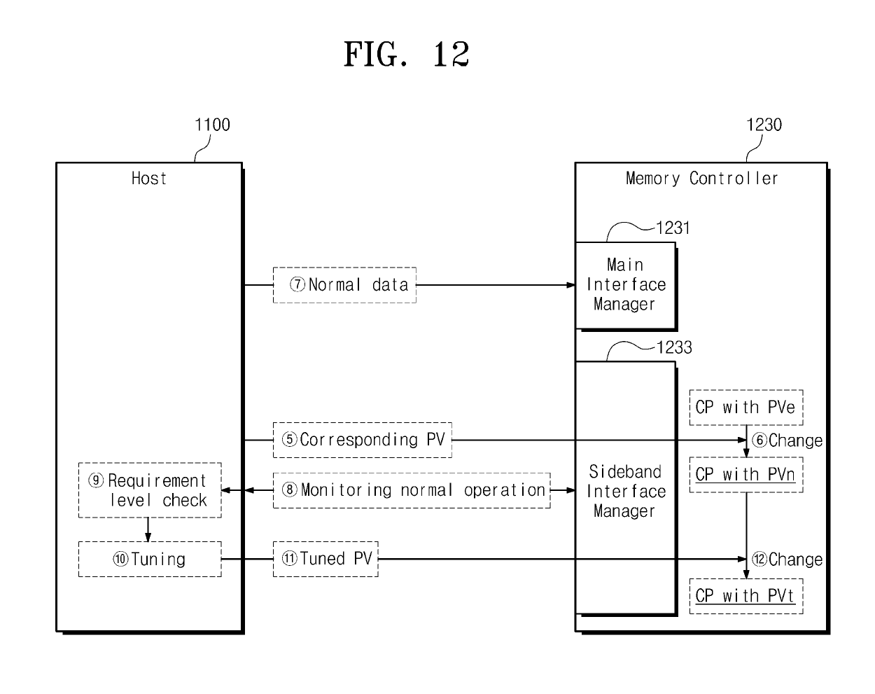

In some example embodiments, the method of FIG. 11 may be performed by the host 1100 of FIG. 1, and these example embodiments will be described with reference to FIG. 12. In some example embodiments, a part of the method of FIG. 11 may be performed by the storage device 1200, and these example embodiments will be described with reference to FIG. 13.

FIG. 12 is a conceptual diagram illustrating a process of tuning a parameter value by a host according to the method of FIG. 11. Reference is now made to FIGS. 8, 11, and 12.

As described with reference to FIG. 8, the host 1100 may transmit a parameter value corresponding to an approximated aging level to the memory controller 1230 of the storage device 1200 (e.g., refer to operation \textcircled{5}). Further, under the control of the memory controller 1230, an existing value PVe of each of the condition parameters CP may be changed into a new value PVn based on a parameter value received from the host 1100 (e.g., refer to operation \textcircled{6}. Accordingly, the storage device 1200 may operate under a new operation condition defined based on the new value PVn.

The host 1100 may monitor a normal operation of the storage device 1200 after transmitting the parameter value corresponding to the approximated aging level. The host 1100 may transmit normal data to the main interface manager 1231 in compliance with a main interface protocol (e.g., refer to operation \textcircled{7}). The storage device 1200 may perform the normal operation (e.g., storing data storage or outputting data) based on the normal data under the control of the memory controller 1230.

The host 1100 may monitor operation performance and power consumption of the storage device 1200 performing the normal operation (e.g., refer to operation \textcircled{8}). To achieve this, the host 1100 may receive information associated with the operation performance and/or the power consumption of the storage device 1200 from the sideband interface manager 1233 in compliance with a sideband interface protocol. The host 1100 may check whether the operation performance and/or the power consumption of the storage device 1200 meet the requirement level based on the received information (e.g., refer to operation \textcircled{9}.

When the operation performance and/or the power consumption do not meet the requirement level, the host 1100 may tune the parameter value corresponding to the approximated aging level (e.g., refer to operation \textcircled{10}. The parameter value may be tuned such that the operation performance and/or the power consumption meet the requirement level. For example, when the power consumption of the storage device 1200 is higher than the requirement level, a parameter value associated with the number of ways being activated may be tuned to decrease. The host 1100 may transmit the tuned parameter value to the storage device 1200 in compliance with the sideband interface protocol (e.g., refer to operation \textcircled{11}).

The new value PVn of each of the condition parameters CP may be changed into the tuned parameter value PVt received from the host 1100 under the control of the memory controller 1230 (e.g., refer to operation \textcircled{12}). Accordingly, the operation condition of the storage device 1200 may be further changed. Under the changed operation condition defined based on the tuned parameter value PVt, the storage device 1200 may show the operation performance and/or the power consumption that meet the requirement level.

FIG. 13 is a conceptual diagram illustrating a process of tuning a parameter value by a storage device according to the method of FIG. 11. Reference is now made to FIGS. 8 and 13.

As described with reference to FIG. 8, the host 1100 may transmit a parameter value corresponding to an approximated aging level to the memory controller 1230 of the storage device 1200 of FIG. 1 (e.g., refer to operation \textcircled{5}). Further, under the control of the memory controller 1230, the existing value PVe of each of the condition parameters CP may be changed into the new value PVn based on the parameter value received from the host 1100. Accordingly, the storage device 1200 may operate under a new operation condition defined based on the new value PVn.

After the existing value PVn is changed into the new value PVn, the storage device 1200 may receive normal data under the control of the memory controller 1230 (e.g., refer to operation \textcircled{7}). The normal data may be received from the host 1100 through the main interface manager 1231. The storage device 1200 may perform a normal operation (e.g., storing data storage or outputting data) based on the normal data under the control of the memory controller 1230.

The memory controller 1230 may monitor operation performance and power consumption of one or more nonvolatile memories 1210 and the memory controller 1230 of the storage device 1200 during the normal operation (e.g., refer to operation \textcircled{8}). Further, the memory controller 1230 may check whether the operation performance and the power consumption meet a requirement level based on a monitoring result (e.g., refer to operation \textcircled{9}).

When the operation performance and the power consumption do not meet the requirement level, the memory controller 1230 may tune a new value PVn of at least one of the condition parameters CP (e.g., refer to operation \textcircled{10}). The parameter value may be tuned such that the operation performance and the power consumption meet the requirement level. For example, when the operation performance of the storage device 1200 is lower than the requirement level, a parameter value associated with delay of the data transmission may be tuned to decrease.

Accordingly, each of the condition parameters CP may have a tuned parameter value PVt. Further, the storage device 1200 may operate in a changed operation condition defined based on the tuned parameter value PVt. In the changed operation condition, the storage device 1200 may show the operation performance and/or the power consumption that meet the requirement level.

According to the example embodiments described with reference to FIGS. 12 and 13, an operation condition of the storage device 1200 may be not only suitably managed for an aging level, but also may be customized to satisfy a customer's needs, thereby increasing the satisfaction of the customer and/or the end-user.

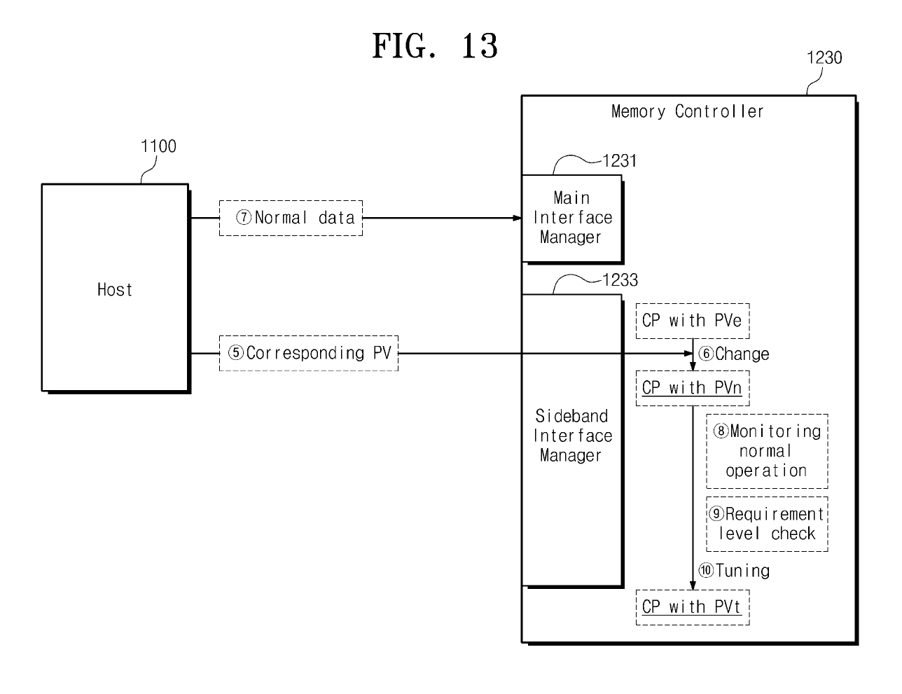

FIG. 14 is a table describing commands that may be defined for an example embodiment. Reference is now made to FIGS. 1, 13, and 14.

In the example embodiments described with reference to FIGS. 1 through 13, it has been mentioned that initiating a management operation and transmitting parameter values of the condition parameters are performed in compliance with a sideband interface protocol. Operations for the example embodiments may be performed by commands previously defined in the sideband interface protocol. Alternatively or in addition, operations for the example embodiments may be performed by defining new commands for the sideband interface protocol.

For example, a command “GetDeviceAge” (i.e., get device age command) may be used when the host 1100 of FIG. 1 receives state data associated with a using state of one or more nonvolatile memories 1210 of FIG. 1 from the storage device 1200 of FIG. 1. For example, the host 1100 may use the command “GetDeviceAge” as an initiation command INIT_CMD of FIG. 8. The host 1100 may notify initiation of a management operation to the storage device 1200 by issuing the command “GetDeviceAge” to the storage device 1200. The storage device 1200 may provide data of a using state of the nonvolatile memories 1210 (i.e., the state data) to the host 1100 in response to the command “GetDeviceAge”.

For example, a command “GetExistingPV” (i.e., get existing PV command) may be used when the host 1100 receives an existing value of each condition parameter CP from the storage device 1200. As described with reference to FIGS. 9 and 10, the host 1100 may receive the existing value of each of the condition parameters by issuing the command “GetExistingPV” to the storage device 1200, and may perform a comparison operation based on the received existing value (e.g., refer to the operation S143 of FIG. 9).

For example, a command “SetTempTh” (i.e., set temperature threshold command) may be used when the host 1100 transmits a parameter value associated with a threshold of an operation temperature to the storage device 1200. Further, a command “SetTransDelay” (i.e., set transmission delay command) may be used when the host 1100 transmits a parameter value associated with a delay of data transmission to the storage device 1200, and a command “SetActiveWays” (i.e., set active ways command) may be used when the host 1100 transmits a parameter value associated with the number of ways being activated to the storage device 1200.

According to the above example, the storage device 1200 may change and/or tune a parameter value associated with the threshold of the operation temperature, based on the parameter value received from the host 1100 in response to the command “SetTempTh.” The storage device 1200 may change or tune a parameter value associated with the delay of data transmission, based on the parameter value received from the host 1100 in response to the command “SetTransDelay.” The storage device 1200 may change or tune a parameter value associated with the number of ways being activated, based on the parameter value received from the host 1100 in response to the command “SetActiveWays.” Accordingly, as described with reference to FIG. 10, the existing value of at least one of the condition parameters may be changed into a new value, or the new value may be changed into a tuned parameter value.

The commands described with reference to FIG. 14 are provided to help better understanding of some example embodiments, and the present disclosure is not limited thereto. In some example embodiments, types and functions of commands may be changed or modified differently from those illustrated in FIG. 14. In some example embodiments, commands having functions which are identical or similar to those illustrated in FIG. 14 from among commands previously defined in the sideband interface protocol may be employed. The example embodiments may be variously changed or modified.

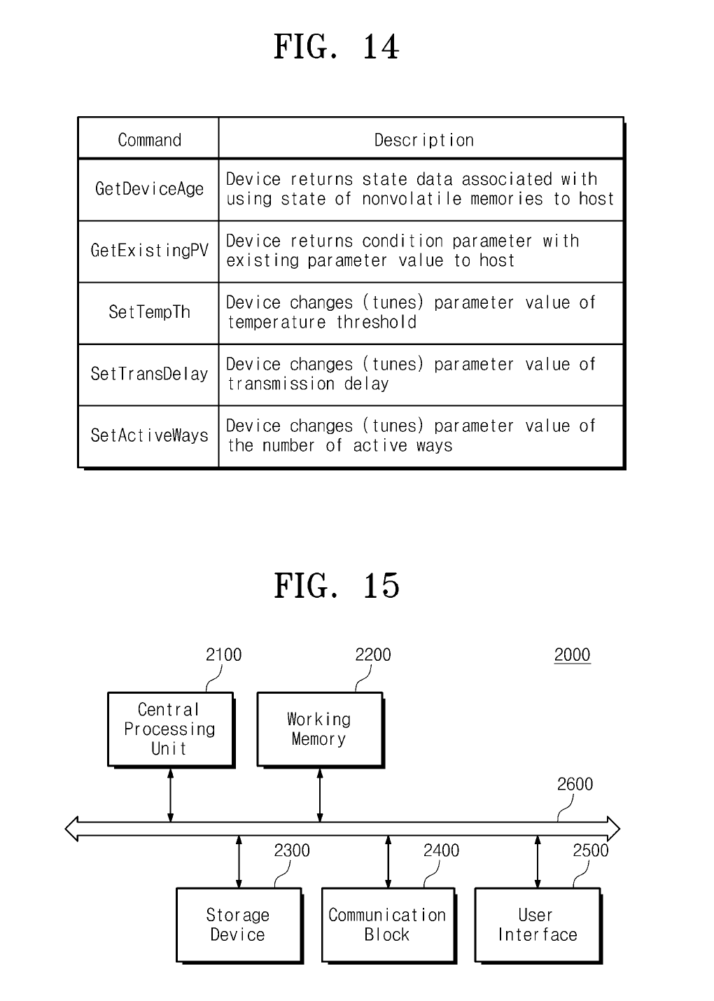

FIG. 15 is a block diagram illustrating a computing device including a storage device in accordance with an example embodiment. A computing device 2000 may include a central processing unit 2100, a working memory 2200, a storage device 2300, a communication block 2400, a user interface 2500, and a bus 2600. For example, the computing device 2000 may be one of various electronic devices, such as a personal computer, a workstation, a notebook, a tablet, etc.

The central processing unit 2100 may control overall operations of the computing device 2000. The central processing unit 2100 may perform various types of arithmetic operations and/or logical operations. For example, the central processing unit 2100 may include a general-purposed processor, a special-purposed processor, or an application processor.

The working memory 2200 may exchange data with the central processing unit 2100. The working memory 2200 may temporarily store data being used in an operation of the computing device 2000. The working memory 2200 may be used as a buffer of the computing device 2000. For example, the working memory 2200 may include a volatile memory system, such as a static RAM (SRAM), a dynamic RAM (DRAM), a synchronous DRAM (SDRAM), and/or the like. The working memory 2200 may include one or more memory modules, or one or more memory packages.

The storage device 2300 may store data that needs to be preserved regardless of power supply. The storage device 2300 may include one or more nonvolatile memories, such as a flash memory, a PRAM, a MRAM, a ReRAM, a FRAM, and/or the like. For example, the storage device 2300 may include a storage medium, such as a solid state drive (SSD).

The storage device 2300 may be implemented based on at least one of the example embodiments described with reference to FIGS. 1 through 14. An operation condition of the storage device 2300 may be changed based on an aging level of one or more memories included in the storage device 2300. For this purpose, the storage device 2300 may communicate with a host (e.g., the central processing unit 2100) in compliance with a sideband interface protocol.

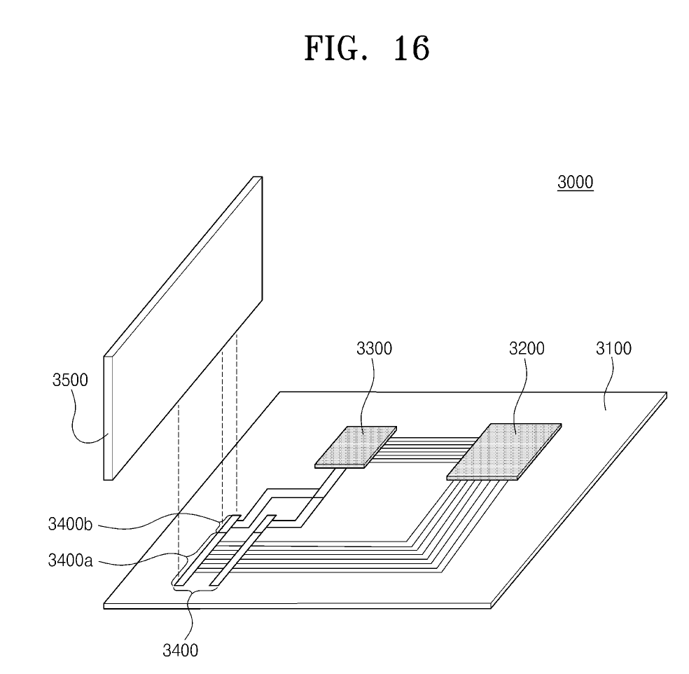

In some example embodiments, the central processing unit 2100 may operate as the host. In these example embodiments, the central processing unit 2100 may manage condition parameter values corresponding to respective different aging levels associated with memories included in the storage device 2300. Further, the central processing unit 2100 may approximate the aging level of memories included in the storage device 2300, and may provide a parameter value corresponding to the approximated aging levels to the storage device 2300. This configuration will be described with reference to FIG. 16.

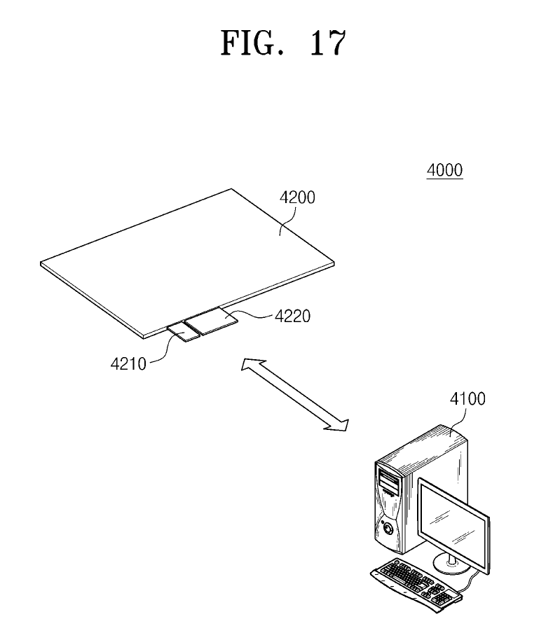

In some example embodiments, a separate computing device or a separate computing system that operates as the host may be further provided. For example, the separate computing device or the separate computing system may include a test/debugging device or a test/debugging system that is configured to test and manage the storage device 2300. This configuration will be described with reference to FIG. 17.

The communication block 2400 may communicate with one or more devices that are external to the computing device 2000 under the control of the central processing unit 2100. The communication block 2400 may communicate with the one or more devices that are external to the computing device 2000 in compliance with a wired communication protocol and/or a wireless communication protocol. For example, the communication block 2400 may communicate with the one or more devices that are external to the computing device 2000 in compliance with one or more various wireless communication protocols, such as long term evolution (LTE), worldwide interoperability for microwave access (WiMax), global system for mobile communication (GSM), code division multiple access (CDMA), Bluetooth, near field communication (NFC), wireless fidelity (WiFi), radio frequency Identification (RFID), etc. and/or one or more various wired communication protocols, such as transfer control protocol/internet protocol (TCP/IP), universal serial bus (USB), small computer small interface (SCSI), PCIe, mobile PCIe (M-PCIe), advanced technology attachment (ATA), parallel ATA (PATA), serial ATA (SATA), serial attached SCSI (SAS), integrated drive electronics (IDE), Firewire, etc.

The user interface 2500 may arbitrate communication between a user and the computing device 2000 under the control of the central processing unit 2100. For example, the user interface 2500 may include input interfaces, such as a keyboard, a mouse, a keypad, a button, a touch panel, a touch screen, a touch pad, a touch ball, a camera, a microphone, a gyroscope sensor, a vibration sensor, and/or the like. The user interface 2500 may also include output interfaces, such as a liquid crystal display (LCD) device, a light emitting diode (LED) display device, an organic LED (OLED) display device, an active matrix OLED (AMOLED) display device, a speaker, a motor, and/or the like.

The bus 2600 may provide a communication path between components of the computing device 2000. The components of the computing device 2000 may exchange data with one another based on a bus format of the bus 2600. For example, the bus format may include one or more various protocols, such as USB, SCSI, PCIe, ATA, PATA, SATA, SAS, IDE, universal flash storage (UFS), and/or the like.

According to the example embodiments, the storage device 2300 may be managed and operate suitably for its aging level and its individual characteristic. Accordingly, the storage device 2300 may operate and may be controlled efficiently. Further, satisfaction of a customer and an end-user may be maximized

FIG. 16 is a conceptual diagram illustrating a computing system including a storage device in accordance with an example embodiment. The computing system 3000 may be identical or similar to the computing device 2000 of FIG. 15.

The computing system 3000 may include a main board 3100. The main board 3100 may be provided to fix and connect various circuits, chips, and/or devices used in an operation of the computing system 3000.

A processor 3200 may be disposed on the main board 3100. The processor 3200 may perform various arithmetic operations and/or logical operations to control overall operations of the computing system 3000. The processor 3200 may include one or more process cores that are capable of performing arithmetic operations and/or logical operations.

An input/output circuit 3300 may be disposed on the main board 3100. The input/output circuit 3300 may provide a communication path between various circuits, chips and devices disposed on the main board 3100. Further, the input/output circuit 3300 may provide a communication path between the outside of the computing system 3000 (e.g., a user of the computing system 3000) and the computing system 3000. A conductive pattern which is printed on the main board 3100 and/or a conductor formed inside the main board 3100 may be used as a communication path.

The main board 3100 may include one or more device slots 3400. The device slots 3400 may be provided to connect peripheral devices, such as a graphic card device, a local area network card device, a storage device, and/or the like, to the main board 3100. In some example embodiments, each of the device slots 3400 may include a main interface port 3400a for providing a communication path in compliance with a main interface protocol and a sideband interface port 3400b for providing a communication path in compliance with a sideband interface protocol. The main interface port 3400a may support a communication protocol, such as PCIe, accompanying a sideband interfacing.

For example, a storage device 3500 may be connected to one of the device slots 3400. The storage device 3500 may be identical or similar to the storage device 1200 of

FIG. 2. For example, the main interface connector 1251 of FIG. 2 may be connected to the main interface port 3400a, and the sideband interface connector 1253 of FIG. 2 may be connected to the sideband interface port 3400b. Accordingly, the storage device 3500 may directly or indirectly communicate with the processor 3200 in compliance with the main interface protocol. Further, the storage device 3500 may communicate with the processor 3200 through the input/output circuit 3300 in compliance with the sideband interface protocol.

The processor 3200 and the storage device 3500 may be implemented based on at least one of the example embodiments described with reference to FIGS. 1 through 14. For example, an operation condition of the storage device 3500 may be changed based on an aging level of one or more memories included in the storage device 3500.

The processor 3200 may manage condition parameter values corresponding to respective different aging levels associated with the memories included in the storage device 3500. Further, the processor 3200 may approximate the aging level of the memories included in the storage device 3500, and may provide a parameter value corresponding to the approximated aging level to the storage device 3500. The processor 3200 may communicate with the storage device 3500 in compliance with the sideband interface protocol.

FIG. 17 is a conceptual diagram illustrating a management system for a storage device in accordance with an example embodiment. A management system 4000 may include a management device 4100 and a storage device 4200.

The management device 4100 may be used to manage the storage device 4200. The management device 4100 may test an operation of the storage device 4200 and/or may debug an error associated with the storage device 4200. The management device 4100 may be an electronic device having arithmetic operation ability, such as a personal computer, a test device, a tablet, or the like.

The storage device 4200 may include a main interface connector 4210 and a sideband interface connector 4220. The main interface connector 4210 may provide a communication path in compliance with the main interface protocol, and the sideband interface connector 4220 may provide a communication path in compliance with the sideband interface protocol. The management device 4100 may be connected to the storage device 4200 through the main interface connector 4210 and/or the sideband interface connector 4220.

In some example embodiments, the storage device 4200 may be directly connected to the management device 4100. In these example embodiments, the management device 4100 may directly communicate with the storage device 4200 in compliance with the main interface protocol and/or the sideband interface protocol. In some example embodiments, the storage device 4200 may be equipped on the main board 3100 of FIG. 16, and the management device 4100 may be connected to the main board 3100 through an external port that supports a communication protocol such as USB, Firewire, or the like. In these example embodiments, the management device 4100 may communicate with the storage device 4200 through the input/output device 3300 and the device slots 3400 of FIG. 16.

The management device 4100 and the storage device 4200 may be implemented based on at least one of the example embodiments described with reference to FIGS. 1 through 14. For example, an operation condition of the storage device 4200 may be changed based on an aging level of one or more memories included in the storage device 4200.

The management device 4100 may manage condition parameter values corresponding to respective different aging levels associated with the memories included in the storage device 4200. Further, the management device 4100 may approximate the aging level of the memories included in the storage device 4200, and may provide a parameter value corresponding to the approximated aging level to the storage device 4200. For this purpose, the management device 4100 may communicate with the storage device 4200 in compliance with the sideband interface protocol.

It has been described that a storage device including nonvolatile memories employs the example embodiments of the present disclosure. However, the example embodiments may be applied to all kinds of memory systems that employ the “sideband interface”. For example, a volatile memory system such as a DRAM system that operates in compliance with a dual in-line memory module (DIMM) scheme may employ the sideband interface and may manage an operation condition based on an aging level according to the example embodiments.

Circuits, chips and devices according to example embodiments of the present disclosure may be mounted using various types of semiconductor packages, such as package on package (PoP), ball grid array (BGA), chip scale package (CSP), plastic leaded chip carrier (PLCC), plastic dual in-line package (PDIP), die in waffle pack, die in wafer form, chip on board (COB), ceramic dual in-line package (CERDIP), metric quad flat pack (MQFP), thin quad flat pack (TQFP), small outline integrated circuit (SOIC), shrink small outline package (SSOP), thin small outline package (TSOP), system in package (SIP), multi chip package (MCP), wafer-level fabricated package (WFP), wafer-level processed stack package (WSP), and/or the like.

The configuration shown in each of schematic diagrams is only to be understood just from a conceptual point of view. To help better understanding of the present disclosure, forms, structures, sizes, or the like of each component shown in each conceptual diagram have been exaggerated or reduced. A configuration actually implemented may have a different physical shape from that shown in each conceptual diagram. Each conceptual diagram is not intended to limit the physical shape or size of the components.

A device configuration shown in each block diagram is provided to help better understanding of the present disclosure. Each block may be formed of smaller blocks according to functions. Alternatively or in addition, a plurality of blocks may form a larger block according to a function. That is, the spirit or the scope of the present disclosure is not limited to the configuration shown in a block diagram.

According to example embodiments of the present disclosure, a storage device may be managed and operate suitably for its aging level and its individual characteristic. Thus, the storage device may be effectively controlled and may effectively operate. Further, the storage device may be customized to satisfy customer's needs, and satisfaction of a customer and an end-user may be maximized

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A storage device comprising:
one or more nonvolatile memories; and
a memory controller configured to control the one or more nonvolatile memories,
wherein the memory controller is further configured to receive a new value from a host in compliance with a sideband interface protocol, the sideband interface protocol being separate from a main interface protocol for transmitting normal data,
wherein the memory controller is further configured to manage a condition parameter associated with an operation condition of the one or more nonvolatile memories and the memory controller, and
wherein the memory controller is further configured to change an existing value of the condition parameter into the new value according to an aging level of the one or more nonvolatile memories.

2. The storage device of claim 1, wherein the condition parameter comprises at least one of a threshold of an operation temperature of the one or more nonvolatile memories and the memory controller, a delay of data transmission with the host, or a number of ways being activated in each of the one or more nonvolatile memories.

3. The storage device of claim 1, wherein the memory controller is further configured to:
manage data of a using state associated with at least one of a number of times that program and erase operations are performed in the one or more nonvolatile memories, an amount of memory blocks discarded in the one or more nonvolatile memories, or an amount of remaining spare blocks that are to replace the discarded memory blocks, and
provide the data of the using state to the host in compliance with the sideband interface protocol in response to a request of the host.

4. The storage device of claim 3, wherein the host is configured to approximate the aging level based on the data of the using state.

5. The storage device of claim 4, wherein the host is configured to prepare parameter values corresponding to respective different aging levels associated with the one or more nonvolatile memories, for the condition parameter, and
wherein the new value is a parameter value corresponding to the approximated aging level from among the prepared parameter values.

6. The storage device of claim 1, wherein after the existing value is changed into the new value, the memory controller is configure to monitor operation performance and power consumption of the one or more nonvolatile memories and the memory controller.

7. The storage device of claim 6, wherein when the operation performance and the power consumption do not meet a requirement level, the memory controller is further configured to tune the new value such that the operation performance and the power consumption meet the requirement level.

8. A method of managing a storage device including one or more nonvolatile memories, the method comprising:
preparing parameter values in a memory of a host for each of one or more condition parameters, the parameter values corresponding to respective different aging levels associated with the one or more nonvolatile memories, the one or more condition parameters being associated with an operation condition of the storage device;
receiving, by the host, state data associated with using states of the one or more nonvolatile memories from the storage device;
approximating, by the host, an aging level of the one or more nonvolatile memories based on the state data; and
transmitting, by the host, a parameter value corresponding to the approximated aging level from among the prepared parameter values to the storage device, for at least one of the condition parameters.

9. The method of claim 8, wherein the condition parameters comprise at least one of a threshold of an operation temperature of the storage device, a delay of data transmission between the storage device and the host, or a number of ways being activated in each of the one or more nonvolatile memories.

10. The method of claim 8, wherein the state data comprises at least one of a number of times that program and erase operations are performed in the one or more nonvolatile memories, an amount of memory blocks discarded in the one or more nonvolatile memories, or an amount of remaining spare blocks that are to replace the discarded memory blocks.

11. The method of claim 8, wherein the transmitting the parameter value corresponding to the approximated aging level comprises:
receiving, by the host, an existing value of each of the condition parameters from the storage device;
comparing the parameter value corresponding to the approximated aging level with the existing value; and
transmitting, by the host, the parameter value corresponding to the approximated aging level to the storage device, when the existing value is different from the parameter value corresponding to the approximated aging level.

12. The method of claim 8, further comprising:
transmitting, by the host, the state data and the parameter value corresponding to the approximated aging level from among the prepared parameter values in compliance with a sideband interface protocol that is separate from a main interface protocol for transmitting normal data.

13. The method of claim 8, further comprising:
monitoring, by the host, operation performance and power consumption of the storage device, after transmitting the parameter value corresponding to the approximated aging level from among the prepared parameter values to the storage device.

14. The method of claim 13, wherein the monitoring the operation performance and the power consumption of the storage device comprises:
transmitting, by the host, normal data to the storage device in compliance with a main interface protocol for transmitting the normal data; and
receiving, by the host, information associated with the operation performance and the power consumption of the storage device that operates based on the normal data, from the storage device in compliance with a sideband interface protocol that is separate from the main interface protocol.

15. The method of claim 13, further comprising:
when the operation performance and the power consumption do not meet a requirement level, tuning, by the host, the parameter value corresponding to the approximated aging level from among the prepared parameter values such that the operation performance and the power consumption meet the requirement level; and
transmitting, by the host, the tuned parameter value to the storage device.

16. A method of managing a storage device including one or more nonvolatile memories, the method comprising:
preparing, by a host, one or more parameter values respectively corresponding to different aging levels;
receiving, by the host, state data from the storage device;
approximating, by the host, an aging level of the one or more nonvolatile memories based on the state data; and
transmitting, by the host, a parameter value from among the one or more parameter values corresponding to the approximated aging level to the storage device.

17. The method of claim 16, further comprising:
receiving, by the host, an existing value from the storage device; and
comparing, by the host, the existing value with the parameter value corresponding to the approximated aging level.

18. The method of claim 17, further comprising:
determining, by the host, whether the existing value is different from the parameter value corresponding to the approximated aging level; and
in response to determining that the existing value is different from the parameter value corresponding to the approximated aging level, transmitting the parameter value corresponding to the approximated aging level to the storage device.

19. The method of claim 16, further comprising:
monitoring, by the host, a normal operation of the storage device;
determining, by the host, whether or not a requirement level is met; and
in response to determining that the requirement level is not met, tuning the parameter value corresponding to the approximated aging level for the storage device.

20. The method of claim 19, further comprising:
in response to determining that the requirement level is not met, transmitting the tuned parameter value to the storage device.
